(19) United States
(12) Patent Application Publication
(10) Pub. No.: US 2021/0302031 A1
(43) Pub. Date: Sep. 30, 2021

(54) Temperature Controlled Deck Board

(71) Applicant: SIGMA DEK LTD., Calgary (CA)

(72) Inventor: Tory Weber, Calgary (CA)

(21) Appl. No.: 17/266,273

(22) PCT Filed: Jun. 11, 2019
(86) PCT No.: PCT/CA2019/050822

§ 371 Date: Feb. 5, 2021

Related U.S. Application Data
(60) Provisional application No. 62/715,519, filed on Aug. 7, 2018.

(51) Int. Cl. F24D 13/04; F24D 13/02; H05B 3/20

(52) U.S. Cl. CPC F24D 13/04; H05B 3/20; F24D 13/02

(57) ABSTRACT

A deck assembly is formed of a plurality of deck boards spanning across a second of joist members to provide structural support between the joist members. Each deck board includes a base frame with an upper panel having an upper supporting surface and a plurality of support legs extending downwardly from the upper panel in engagement with the joist members to support the upper panel spaced above the joist members. Each deck board also has one or more channels formed in the upper panel so as to define an elongate passage which is recessed downwardly relative to the upper panel and which is open at a top side at the upper supporting surface of the upper panel to receive an elongated flexible heating member within the channels of the deck boards. Panels of finishing material on the upper supporting surfaces span over the heating member.

### FIELD OF THE INVENTION

The present invention relates to a deck board suitable for spanning across joists in a deck structure in which passages are provided within the deck board to receive an elongate heating member, for example of an electrical resistant heating element or a fluid conduit for heating or cooling the deck board.

### BACKGROUND

Use of heating members such as an electrical resistant type heating element or heat exchanger tubing to carry a heating exchanger liquid through a floor within a building is well known to provide heating and cooling to the building. Typically, the building floor is constructed in the usual manner with floor joists and a subfloor of plywood sheets spanning over the floor joists. The heating members are then laid in a second layer over the subfloor, for example by being embedded within a mortar bed. Finishing material, typically flooring tiles, are then supported over the mortar bed.

The following United States Patent and US Patent Application Publication documents disclose various examples of heated flooring systems: US2007/0017656 by Da Rold; U.S. Pat. No. 8,025,240 by Keller; U.S. Pat. No. 5,788,152 by Alsbert; and U.S. Pat. No. 4,782,889 by Bourne. None of the prior art examples are well suited for ease of installation directly overtop of exterior deck joists while accepting a variety of different heating members and a variety of different finishing materials therein.

### SUMMARY OF THE INVENTION

According to one aspect of the invention there is provided a deck board for supporting an elongated flexible heating member relative to a plurality of parallel and spaced apart joist members, the deck board comprising:

a base frame comprising an upper panel having an upper supporting surface for receiving a panel of finishing material supported thereon and a plurality of support legs extending downwardly from the upper panel for engaging the joist members to support the upper panel spaced above the joist members;

at least one channel formed in the upper panel so as to define an elongate passage which is recessed downwardly relative to the upper panel and which is open at a top side at the upper supporting surface of the upper panel;

the at least one channel being sized to receive the heating member longitudinally therein such that the panel of finishing material supported on the upper supporting surface spans over the heating member.

According to a second aspect of the present invention there is provided a deck assembly comprising

a plurality of parallel and spaced apart joist members;

a plurality of deck boards spanning across the joist members, providing structural support between the joist members, each deck board comprising (i) a base frame comprising an upper panel having an upper supporting surface and a plurality of support legs extending downwardly from the upper panel in engagement with the joist members to support the upper panel spaced above the joist members, and (ii) at least one channel formed in the upper panel so as to define an elongate passage which is recessed downwardly relative to the upper panel and which is open at a top side at the upper supporting surface of the upper panel;

an elongated flexible heating member received within the channels of the deck boards;

a plurality of panels of finishing material supported on the upper supporting surfaces of the deck boards to span over the heating member.

The deck boards described herein can be readily mounted directly overtop of exterior deck joists with the channels being openly accessible to readily accept a variety of different heating members therein subsequent to mounting of the deck boards on the deck joists. The deck boards are also well suited to accepting a variety of different finishing materials therein once the heating members have been mounted in place.

The deck board may further include a cap member associated with said at least one channel in which the cap member is receivable within the channel so as to be arranged to enclose the heating member within the channel. Preferably the cap member has a top surface which lies substantially coplanar with the upper supporting surface of the base frame in a mounted position. The cap member may also include hooking elements formed thereon which are arranged to be engaged upon catches formed in the base frame so as to selectively retain the cap member mounted within the channel.

In preferred embodiments, the deck board further includes a fastener flange formed on the base frame to extend laterally outwardly below the upper supporting surface in a common plane with a bottom of the support legs so as to be arranged to receive a fastener for fastening the frame to the joists.

Also in preferred embodiments, the deck board further includes a tongue element formed on the base frame to protrude laterally outwardly beyond a first side edge of the upper supporting surface and a groove element formed on the base frame below a second side edge of the upper supporting surface which is adapted to receive the tongue element of an adjacent deck board of identical configuration.

A pair of side flanges may extend upwardly from opposing side edges of the upper supporting surface to receive the panel of finishing material therebetween.

The deck board may be used in combination with a heating member that comprises an electrical resistance type heating element, or alternatively, a heating member that comprises an elongate tube containing a heat exchanging liquid therein.

The panel of finishing material is preferably bonded directly to the upper supporting surface of the base frame, for example using an adhesive material or mortar.

### BRIEF DESCRIPTION OF THE DRAWINGS

Various embodiments of the invention will now be described in conjunction with the accompanying drawings in which:

FIG. 1 is a schematic view of a first embodiment of the deck assembly;

FIG. 2 is a sectional view across one of the deck boards of the deck assembly according to the first embodiment of FIG. 1;

FIG. 3 is a perspective view of one end of one of the deck boards in the deck assembly according to the first embodiment of FIG. 1;

FIG. 4 is a schematic view of a second embodiment of the deck assembly;

FIG. 5 is a sectional view across one of the deck boards of the deck assembly according to the second embodiment of FIG. 4; and

FIG. 6 is a perspective view of one end of one of the deck boards in the deck assembly according to the second embodiment of FIG. 4.

In the drawings like characters of reference indicate corresponding parts in the different figures.

### DETAILED DESCRIPTION

Referring to the accompanying figures there is illustrated a deck assembly generally indicated by reference numeral 10. The deck assembly includes a plurality of deck joists 12 which are mounted to span parallel and spaced apart from one another between a ledger board (not shown) at one end of the joists and a support beam (not shown) spaced apart from the ledger board towards the other end of the joists. A plurality of deck boards 13 are mounted to span across the joists in perpendicular relation thereto. The deck boards define a suitable passage to receive one or more elongate heating members 15 therein as described in the following.

Each deck board 13 comprises an elongate extruded metal profile spanning in a longitudinal direction between opposing ends of the deck board. The deck board is continuous in profile along the full length thereof and is of suitable length to span across a plurality of the spaced apart joists.

Each deck board includes a base frame comprises of an upper panel 14 and a plurality of support legs 16 extending downwardly from the upper panel. The upper panel may be formed in one or more sections which are spaced apart from one another in a lateral direction and which span the full length in the longitudinal direction within a common plane relative to one another. The upper panels define a flat rigid upper supporting surface 18 arranged to support panels of finishing material thereon as described in further detail below.

The support legs 16 comprise upright flanges which extend downwardly from the bottom side of the upper panel to respective bottom ends which lie in a common plane parallel to the upper panel at the bottom of the base frame of the deck board. The bottom ends of the support legs are thus suited for directly engaging the top side of the joists to support the upper panel 14 spaced above the joists. Each of the support legs further includes a footing flange 19 in the form of a flat plate oriented perpendicular to the leg and parallel to the upper panel for engaging flat against the top side of the joists.

The base frame of each deck board further includes two side flanges 20 which extend upwardly from opposing side edges of the upper panel so that the side flanges are perpendicular to the upper panel while being parallel and spaced apart from one another at laterally opposing sides of the upper panel. The side flanges 20 and the upper panel 14 collectively define a U-shaped trough open to the top side which accepts the finishing material panel 22 therein.

The base frame further includes a tongue element 24 mounted at a first side of the upper panel in the form of a flange protruding laterally outwardly immediately below the upper panel while extending laterally outwardly beyond the side flange 20 at the corresponding side edge of the upper panel.

At a second side of the upper panel, the base frame defines a groove element 26 in the form of an undercut surface directly below the upper panel which is open laterally to the outer side of the deck board. The groove element is adapted to receive the tongue element of an adjacent deck board of identical configuration therein when the deck boards are mounted parallel and adjacent to one another on the top side of the joists.

A lower flange 28 forms the lower boundary of the groove element 26 by being spaced below the undercut surface of the groove element at the second side of the base frame. The lower flange terminates directly below the corresponding side edge of the upper panel for mounting a fastener flanges 30 thereon in which the fastener flange extends laterally outwardly beyond the corresponding side edge of the upper panel at a location spaced below the upper panel at the bottom side of the base frame.

The fastener flange is parallel to the upper panel so as to be coplanar with the bottom ends of the support legs 16 so that the fastener flange lies flat against the top side of the joists to receive fasteners therethrough which fasten the deck board to the joists in a mounted position.

Each deck board also includes a plurality of heating channels 32 formed therein in which each channel defines a passage open at the top side through a respective opening in the upper panel to span the full length of the deck board in the longitudinal direction. The passage is fully recessed below the upper panel. The passage of the heating channel is defined by a pair of side walls 34 extending downwardly from the upper panel at opposing boundary edges of a corresponding opening in the upper panel. A bottom section is connected between the two sides 34 at a location spaced below the upper panel so that the bottom 36 and the two sides 34 collectively define a U-shaped boundary of the heating channel.

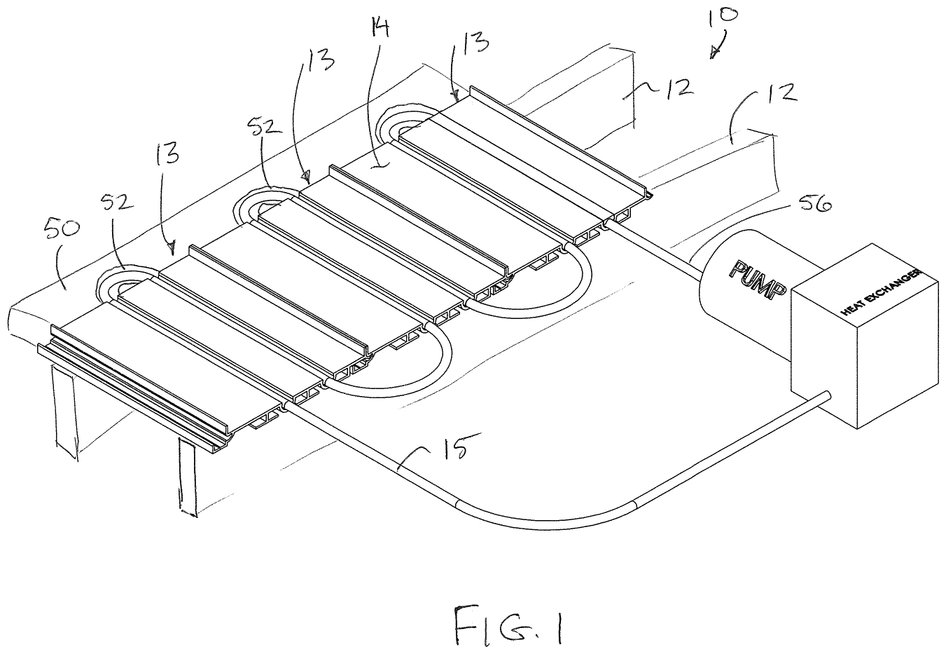

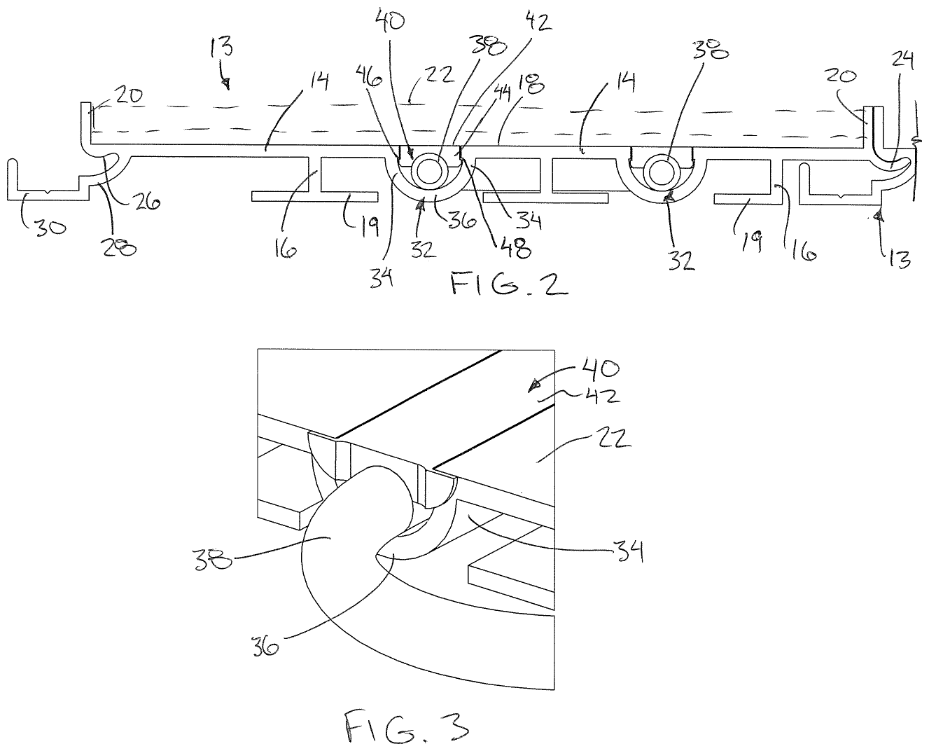

Turning now more particularly to the first embodiment of FIGS. 1 through 3, the heating channels in this instance are adapted for receiving a heating member therein in which the heating member comprises elongate flexible tubing 38 adapted to receive a flow of heat exchanger liquid therethrough. The heating channel in this instance is generally semicircular in shape in which the bottom 36 is generally concave at the interior of the channel to conform to the circular shape of the tubing 38. The bottom 36 of each heating channel in this instance is substantially coplanar with the bottom ends of the support legs such that the channels span the full height of the support legs to accommodate the diameter of the tubing 38.

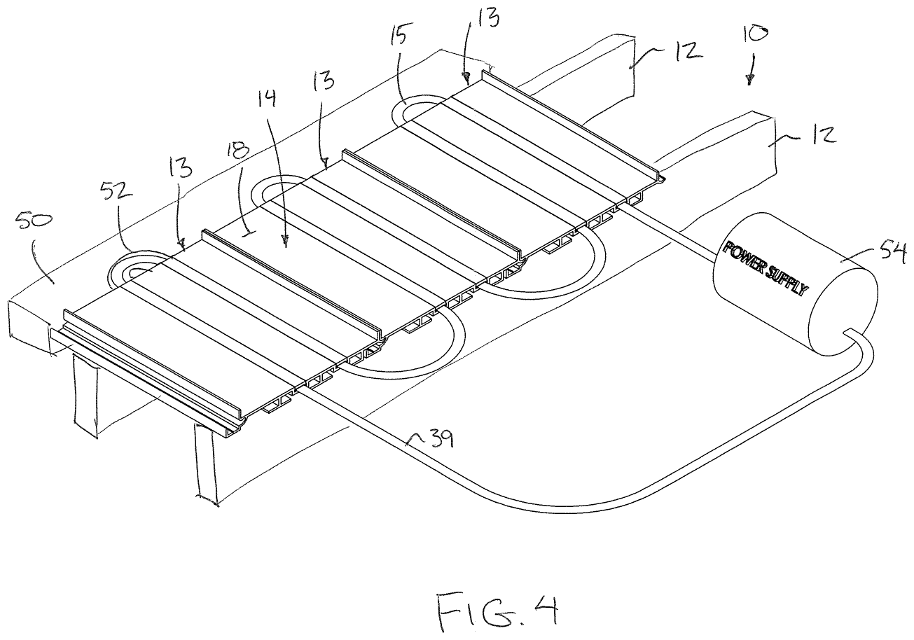

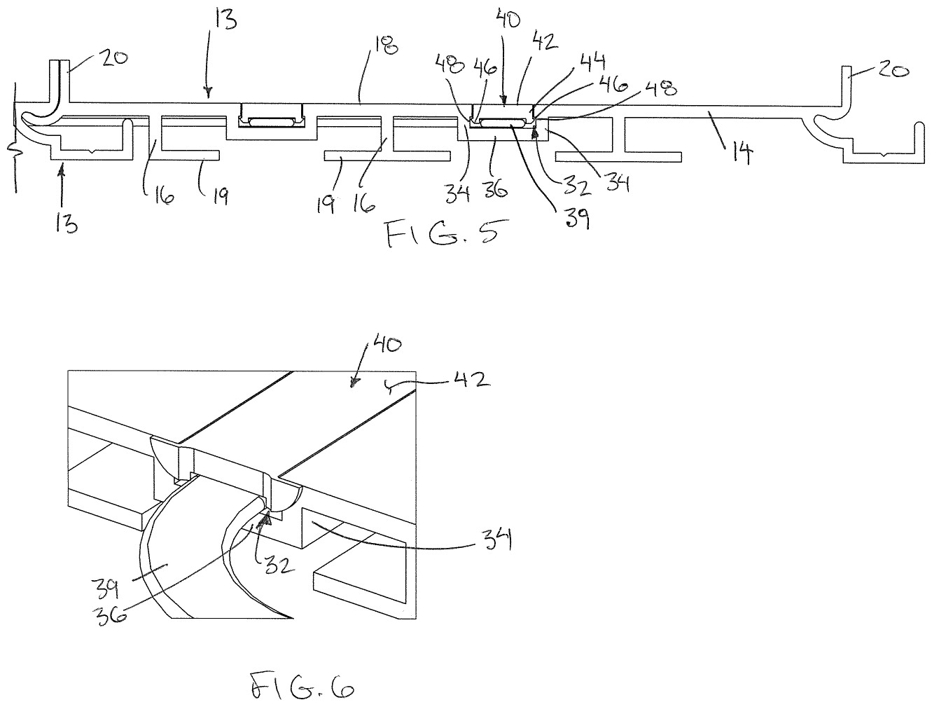

Turning now more particularly to the second embodiment of FIGS. 4 through 6, the heating channels in this instance are adapted for receiving a heating member in which the heating member comprises an elongate flexible electrical resistance type heating element 39. The heating channel in this instance is generally rectangular in shape in which the bottom 36 is generally flat and parallel to the upper panel at an intermediate location spaced below the upper panel and spaced above the bottom end of the support legs.

In both embodiments, each heating channel is enclosed by a cap member 40 which fits in the channel and which spans the full length of the channel in the longitudinal direction. The cap member includes a flat top 42 spanning the full width of the opening in the upper panel to be substantially coplanar and flush with the upper panel at the top side thereof. The cap member further includes two side walls 44 extending downwardly from opposing side edges of the top 42 having an outer dimension corresponding approximately to the inner dimension between the two sides 34 of the heating channels. A pair of hooks 46 are formed on the side walls 44 to protrude laterally outwardly therefrom at a location spaced below the flat top 42 for selectively retaining the cap member within the respective channel. In this instance each channel includes two recessed grooves formed in the opposing sides 34 thereof in which each recess defines an undercut surface forming a catch 48 so that the two catches 48 selectively retain the two hooks 46 thereon in a mounted position of the cap member. The cap member may be formed of a suitable plastic material in which the side walls 44 are sufficiently resilient to permit the hooks to be flexed inwardly as the cap is inserted through the upper opening in the upper panel until the hooks are aligned with the catches 48 resulting in the cap member being snap fit into the respective channel so as to fully enclose and cover the heating member within the channel. The bottom surface of the cap member is suitably shaped to match the profile of the corresponding heating member received within the channel.

In use, a plurality of the deck boards 13 are mounted in side-by-side relationship to one another to span perpendicularly across a plurality of the joists. Each deck board is mounted by penetrating fasteners through the fastener flange 30 thereof into the joists therebelow. Once a first deck board has been installed, each subsequent deck board is mounted by initially inserting the tongue element 24 thereof into the groove element 26 of a previously installed the deck board followed by fastening through the fastener flange 30 thereof at the opposing second side so that both sides of the deck board are held snugly against the top side of the joists.

A suitable header member 50 may be mounted across the ends of all of the deck boards having a plurality of U-shaped grooves 52 formed in the upper supporting surface thereof in which the U-shaped grooves 52 are each connected between a corresponding pair of channels 32 either in the same or in an adjacent deck boards of the overall deck assembly. In this manner all of the channels 32 are interconnected to form a continuous passage receiving a single elongate flexible heating member therein. After installation of the heating member within the channels, the cap members can be mounted within the channels to enclose the heating member in the top side of the deck board.

A finishing material panel is then mounted onto the upper supporting surface of each deck board. For example, the finishing material may comprise a plastic, composite, or wood panels, or alternatively may comprise tiles formed of various materials which are mounted on the top side of each deck board to span the full length of the deck board and to span the full width between the two side flanges thereof. A layer of adhesive material, or mortar in the instance of tiles, can be used to bond the finishing panels to the upper supporting surface of the deck boards such that the finishing panels lie substantially flush and in a common plane with the top edges of the side flanges 20.

Each finishing panel may span the full length and the full width between side flanges 20 of a respective one of the deck boards such that each deck board includes a respective finishing panel associated therewith. Alternatively, a plurality of finishing panels may collectively fully span the length and width of a respective one of the deck boards. In yet a further arrangement, a single finishing panel may span the length of a plurality of deck boards abutted end to end longitudinally in series while spanning the full width of the deck boards also.

In the instance of an electrical heating member, the heating member is connected to a suitable power source 54 as shown in FIG. 4 so that the power source can be used to control the amount of electricity passed through the heating element to control the heating thereof.

Alternatively, in the instance of a tubular heating member carrying a heat exchanger liquid therein, the heating member is connected within a heat exchanger liquid circuit 56 as shown in FIG. 1 including a pump for circulating the liquid and the heat exchanger where heat can be added to or removed from the liquid depending upon whether the heating member is used for adding heat to the deck assembly or removing heat from the deck assembly.

Since various modifications can be made in my invention as herein above described, and many apparently widely different embodiments of same made, it is intended that all matter contained in the accompanying specification shall be interpreted as illustrative only and not in a limiting sense.

1. A deck board for supporting an elongated flexible heating member relative to a plurality of parallel and spaced apart joist members, the deck board comprising:
a base frame comprising an upper panel having an upper supporting surface for receiving a panel of finishing material supported thereon and a plurality of support legs extending downwardly from the upper panel for engaging the joist members to support the upper panel spaced above the joist members;
at least one channel formed in the upper panel so as to define an elongate passage which is recessed downwardly relative to the upper panel and which is open at a top side at the upper supporting surface of the upper panel;
the at least one channel being sized to receive the heating member longitudinally therein such that the panel of finishing material supported on the upper supporting surface spans over the heating member.

2. The deck board according to claim 1 further comprising a cap member associated with said at least one channel, the cap member being receivable within the channel so as to be arranged to enclose the heating member within the channel.

3. The deck board according to claim 2 wherein the cap member has a top surface which lies substantially coplanar with the upper supporting surface of the base frame in a mounted position.

4. The deck board according to claim 2 wherein the cap member includes hooking elements formed thereon which are arranged to be engaged upon catches formed in the base frame so as to selectively retain the cap member mounted within the channel.

5. The deck board according to claim 1 further comprising a fastener flange formed on the base frame to extend laterally outwardly below the upper supporting surface in a common plane with a bottom of the support legs so as to be arranged to receive a fastener for fastening the frame to the joists.

6. The deck board according to claim 1 further comprising a tongue element formed on the base frame to protrude laterally outwardly beyond a first side edge of the upper supporting surface and a groove element formed on the base frame below a second side edge of the upper supporting surface which is adapted to receive the tongue element of an adjacent deck board of identical configuration.

7. The deck board according to claim 1 further comprising a pair of side flanges extending upwardly from opposing side edges of the upper supporting surface to receive the panel of finishing material therebetween.

8. The deck board according to claim 1 in combination with the heating member in which the heating member comprises an electrical resistance type heating element.

9. The deck board according to claim 1 in combination with the heating member in which the heating member comprises an elongate tube containing a heat exchanging liquid therein.

10. The deck board according to claim 1 in combination with the panel of finishing material wherein the panel of finishing material is bonded directly to the upper supporting surface of the base frame.

11. A deck assembly comprising:
a plurality of parallel and spaced apart joist members;
a plurality of deck boards spanning across the joist members, providing structural support between the joist members, each deck board comprising (i) a base frame comprising an upper panel having an upper supporting surface and a plurality of support legs extending downwardly from the upper panel in engagement with the joist members to support the upper panel spaced above the joist members, and (ii) at least one channel formed in the upper panel so as to define an elongate passage which is recessed downwardly relative to the upper panel and which is open at a top side at the upper supporting surface of the upper panel;
an elongated flexible heating member received within the channels of the deck boards;
a plurality of panels of finishing material supported on the upper supporting surfaces of the deck boards to span over the heating member.

12. The deck assembly according to claim 11 further comprising a cap member received within the channel of each deck board so as to be arranged to enclose the heating member within the channels.

13. The deck assembly according to claim 12 wherein each cap member has a top surface which lies substantially coplanar with the upper supporting surface of the base frame of the respective deck board.

14. The deck assembly according to claim 12 wherein each cap member includes hooking elements formed thereon which are engaged upon catches formed in the base frame of the respective deck board so as to selectively retain the cap member mounted within the channel.

15. The deck assembly according to claim 1 further comprising a fastener flange formed on the base frame of each deck board which extends laterally outwardly below the upper supporting surface in a common plane with a bottom of the support legs and which receives a fastener that fastens the base frame to the joists.

16. The deck assembly according to claim 1 wherein each deck board further comprises a tongue element formed on the base frame to protrude laterally outwardly beyond a first side edge of the upper supporting surface and a groove element formed on the base frame below a second side edge of the upper supporting surface which receives the tongue element of an adjacent one of the deck boards therein.

17. The deck assembly according to claim 1 each deck board further comprises a pair of side flanges extending upwardly from opposing side edges of the upper supporting surface, the side flanges receiving the panel of finishing material therebetween.

18. The deck assembly according to claim 1 wherein the heating member comprises an electrical resistance type heating element.

19. The deck assembly according to claim 1 wherein the heating member comprises an elongate tube containing a heat exchanging liquid therein.

20. The deck assembly according to claim 1 the panels of finishing material are bonded directly to the upper supporting surfaces of respective ones of the base frame.
